(19) United States
(12) Patent Application Publication
(10) Pub. No.: US 2010/0231809 A1
(43) Pub. Date: Sep. 16, 2010

(54) BROADCAST RECEIVING APPARATUS, AND BROADCAST RECEIVING METHOD

(75) Inventor: Tatsuya SUZUKI, Kyoto (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/706,898

(22) Filed: Feb. 17, 2010

(30) Foreign Application Priority Data
Feb. 19, 2009 (JP) 2009-036198

(51) Int. Cl. H04N 5/50

(52) U.S. Cl. 348/731; 348/E05.097

(57) ABSTRACT

A broadcast receiving apparatus includes a channel scanner that detects presence or absence of receivable services for all channels in the reception bandwidth and that creates a first service list of receivable services, a service list storage that stores a broadcast area and at least one second service list associated with the broadcast area, and a service list integrator that integrates the first service list and the second service list so as to create an integrated service list. In a case where identical services have been registered on an identical physical channel in the first service list and the second service list, the service list integrator integrates the services into one piece of service information.

### BACKGROUND

1. Field

The present application relates to a broadcast receiving apparatus, and a broadcast receiving method.

2. Description of Related Art

Recently, broadcast waves for television broadcasting have been digitalized. Further, accompanying the start of terrestrial digital television broadcasting, a one-segment partial reception service for portable phone terminal or mobile terminal (hereinafter referred to as “one-segment broadcasting”) has started. For the portable phone terminal or mobile terminal, models carrying receivers that can receive the one-segment broadcasting have been increased.

At the time of receiving the one-segment broadcasting at the portable phone terminal or the mobile terminal, it is required to set the reception channel. JP 2006-325032 A discloses a portable digital terrestrial broadcasting receiver. JP 2006-325032 A discloses a channel scan function for scanning sequentially from a channel 13 to a channel 62 and creating a service list. Further, JP 2006-325032 A discloses a flash memory that can register area names and service lists corresponding to the respective areas.

However, in a method of creating a service list by executing the channel scan function, only the service that is received successfully at the moment of executing the channel scan can be registered. That is, even though a broadcast receiver is located in a region corresponding to an arbitrary service list, in a case where a broadcast wave included in the arbitrary service list cannot be received due to any reason such as insufficient intensity of the broadcast wave, the channel scan function may end without registration of the service into the service list.

In a method of selecting a broadcast area name and reading out a service list registered in a flash memory, it is not certain whether a user can select the optimal list at a reception site bridging over plural broadcast areas. For example, in a broadcast area X and a broadcast area Y adjacent to each other, in an attempt to receive a broadcast wave at a position within the broadcast area X and in the vicinity of the border with the broadcast area Y, even though a service registered in the service list corresponding to the broadcast area Y can be received preferably, probably the user will select a service list corresponding to the broadcast area X. Therefore, in the method of selecting the broadcast area name and reading out a service list, a service list most suitable at the reception site cannot be selected necessarily.

### SUMMARY

A broadcast receiving apparatus of the present application is a broadcast receiving apparatus that receives a broadcast wave and reproduces video, audio or data. The broadcast receiving apparatus includes a channel scanner that detects the presence or absence of receivable services for all channels within a reception bandwidth and creates a first receivable service list; a service list storage that stores a broadcast area and at least one second service list associated with the broadcast area; and a service list integrator that integrates the first service list and the second service list so as to create an integrated service list. When identical services have been registered in the first service list and the second service list on an identical physical channel, the service list integrator integrates the services into one piece of service information.

### BRIEF DESCRIPTION OF THE DRAWINGS

FIG. 1 is a block diagram of a broadcast receiving apparatus according to an embodiment of the present application.

FIG. 2A is a flow chart showing an operation for registering a service list in a preset list of the broadcast receiving apparatus according to the embodiment.

FIG. 2B is a flow chart showing a procedure of service list integration.

FIGS. 3A-3C are schematic views showing examples of service lists of the broadcast receiving apparatus according to the embodiment.

FIGS. 4A-4C are schematic views showing examples of service lists of the broadcast receiving apparatus according to the embodiment.

FIGS. 5A-5C are schematic views showing examples of service lists.

### DETAILED DESCRIPTION OF THE EMBODIMENT

A broadcast receiving apparatus receives a broadcast wave and reproduces video, audio or data, the broadcast receiving apparatus comprising: a channel scanner that detects presence or absence of receivable services for all channels within a reception bandwidth and creates a first service list of receivable services; a service list storage that stores a broadcast area and at least one second service list associated with the broadcast area; and a service list integrator that integrates the first service list and the second service list so as to create an integrated service list. In a case where identical services have been registered on an identical physical channel in the first service list and the second service list, the service list integrator integrates the services into one piece of service information.

Thereby, even when reception happens to fail due to a bad reception condition at the time of channel scan and registration is not performed, a reception from an established service list associated with the reception region is available. Further, even a service not included in the established service list can be registered as one service list if the service can be received at the reception site. Moreover, identical services can be held without duplication and thus a lean and simple service list can be created.

In the broadcast receiving apparatus, the broadcast area can be selected from broadcast areas stored in the service list storage. Thereby, a user can select any suitable broadcast area from the established service lists associated with the reception region.

The broadcast receiving apparatus can be configured further to include a memory that is capable of storing the integrated service list as a preset list. Thereby, a newly created service list can be held as a preset list, and thus there is no need of setting a service list in the next use.

The broadcast receiving apparatus can be configured so that in a case where a plurality of identical services of different physical channels have been registered in the first service list, the service list integrator registers service information of the smaller physical channel value preferentially in the integrated service list. Thereby, when reception of identical services is achieved on different physical channels, the services are listed in accordance with an order of reception possibility, or the services are integrated to a physical channel having the higher reception possibility, and thus a simple and convenient service list can be created.

The broadcast receiving apparatus can be configured so that in a case where service information of identical services of different physical channels have been registered in the first service list and the second service list, if a service identical to a service in the second service list has been registered in the first service list on the same physical channel, the service list integrator registers the service information preferentially in the integrated service list. And if a service identical to a service in the second service list has not been registered in the first service list on the same physical channel, the service list integrator registers the service information of the different physical channel in the first service list preferentially in the integrated service list. Thereby, when reception of identical services is achieved on different physical channels, the services are listed in accordance with an order of reception possibility, or the services are integrated to a physical channel having the higher reception possibility, and thus a simple and convenient service list can be created.

### Embodiments

### 1. Configuration of Broadcast Receiving Apparatus

There are mainly two methods for receiving and reproducing a service in a portable broadcast receiving apparatus. A first channel selection method is a method in which a user selects physical channels sequentially and selects a receivable service. A second channel selection method is a method of listing services receivable at an arbitrary reception site and registering them as a preset list in the memory in a broadcast receiving apparatus, from which the user selects an arbitrary service.

Receivable services vary depending on the regions and broadcast areas. Therefore, typically a portable broadcast receiving apparatus stores a plurality of service lists as the preset lists in a flash memory included in the broadcast receiving apparatus.

There are two kinds of methods for registering such a preset list.

A first preset list registering method includes: detecting a service receivable at the current reception site through a channel scan; creating a list; and registering the thus created list in a flash memory included in a broadcast receiving apparatus. For example in a one-segment broadcasting, first, a scan is performed sequentially to see whether the physical channels from channel 13 to channel 62 in the UHF (Ultra High Frequency) bandwidth are receivable or not. Next, a list including the received physical channels and services corresponding thereto is created. Next, the thus created list is registered as a preset list in a flash memory of the broadcast receiving apparatus. JP 2006-325032 A discloses a configuration for executing the channel scan, creating a service list, and registering the thus created service list and an area selected by the user in the memory.

A second preset list registering method is a method of registering lists of receivable services and physical channels for every broadcast area previously as a preset list, in a broadcast receiving apparatus. Specifically, first, data tables are prepared respectively for principal regions in a service area for a broadcast to be received. Next, in a data table of a region to be a subject of broadcasting for a service, the service is registered and entered in a list in advance. Next, the user selects any of the regions so as to register a service to be broadcast in the region in the preset list.

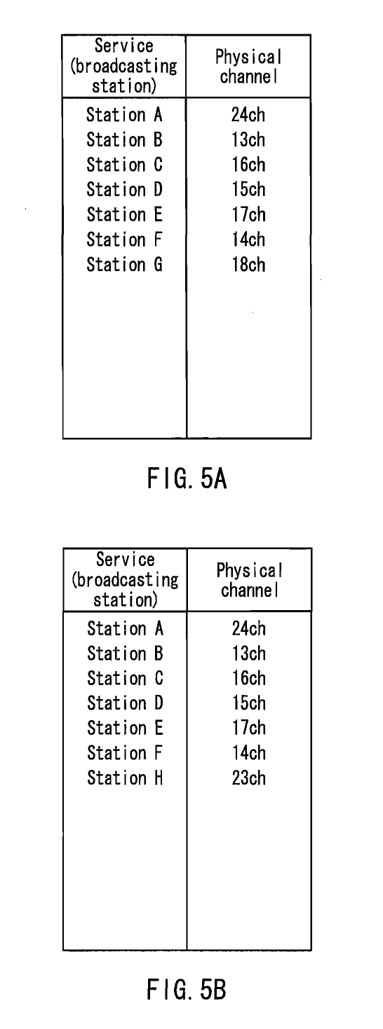

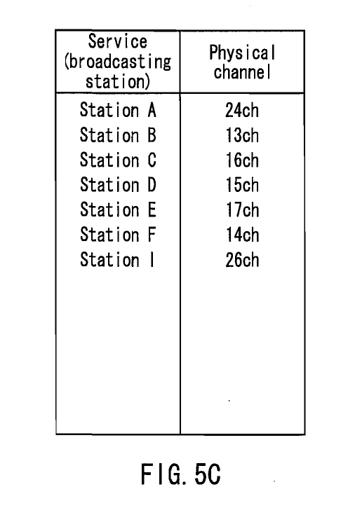

FIG. 5A shows an example of a service list for a broadcast area X in a one-segment broadcasting. FIG. 5B shows an example of a service list for a broadcast area Y. FIG. 5C shows an example of a service list for a broadcast area Z. In FIGS. 5A-5C, since the broadcasting stations A-F are wide-area stations, service information corresponding to the broadcasting stations A-F is registered in the respective service lists for the broadcast areas X, Y and Z. In contrast, since the broadcasting station G as shown in FIG. 5A is a broadcasting station targeted to the broadcast area X, service information corresponding to the broadcasting station G is registered only in the service list for the broadcast area X. Since the broadcasting station H as shown in FIG. 5B is a broadcasting station targeted to the broadcast area Y, service information corresponding to the broadcasting station H is registered only in the service list for the broadcast area Y. Since the broadcasting station I as shown in FIG. 5C is a broadcasting station targeted to the broadcast area Z, service information corresponding to the broadcasting station I is registered only in the service list for the broadcast area Z. In this manner, it is possible to create a service list for every broadcast area.

However, if the broadcast area is wide, it is difficult to send a broadcast wave to an entire broadcast area from one relay station. In such a case, generally a plurality of relay stations send the broadcast wave to the entire region of the broadcast area. In this case, since the physical channels may vary even for the same service, one broadcast area may be divided into plural areas, and service lists for relay stations with different physical channels may be provided to the divided areas respectively. However, since quite a number of relay stations are located, a flash memory of a large capacity will be required to store the service lists of all the relay stations. For this reason, often service lists only of principal relay stations or service lists for principal broadcast areas are stored in the flash memory.

The broadcast receiving apparatus according to the present embodiment serves to solve the above-mentioned problems.

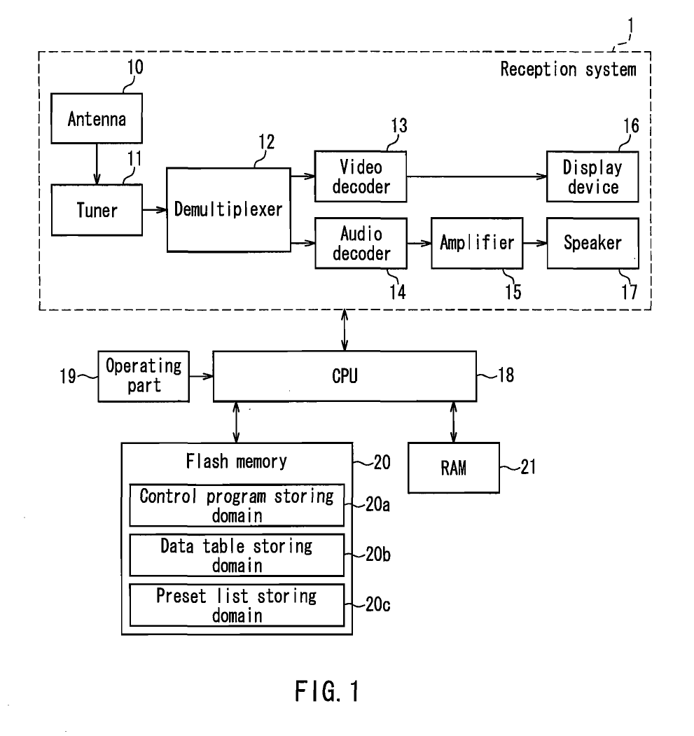

FIG. 1 is a block diagram showing a portable broadcast receiving apparatus according to an embodiment. The broadcast receiving apparatus as shown in FIG. 1 has a reception system 1, a CPU (Central Processing Unit) 18, an operating part 19, and a flash memory 20. The reception system 1 includes an antenna 10, a tuner 11, a demultiplexer 12, a video decoder 13, an audio decoder 14, an amplifier 15, a display device 16 and a speaker 17.

The antenna 10 is capable of receiving a radio wave. The tuner 11 is capable of demodulating the radio wave received at the antenna 10 so as to extract a signal. The demultiplexer 12 is capable of dividing the signal extracted by the tuner 11 into a video stream and an audio stream. The video decoder 13 is capable of transforming the video stream outputted from the demultiplexer 12 into a video signal. The audio decoder 14 is capable of transforming the audio stream outputted from the demultiplexer 12 into an audio signal. The display device 16 is capable of displaying video on the basis of the video signal outputted by the video decoder 13. The amplifier 15 is capable of amplifying the audio signal outputted by the audio decoder 14. The speaker 17 is capable of emitting the audio signal amplified by the amplifier 15, as a sound. The CPU 18 is capable of controlling the reception system 1. The flash memory 20 is capable of preserving the control program and various data. A RAM 21 is capable of storing data temporarily when the CPU 18 executes the various procedures. The operating part 19 accepts operation of the broadcast receiving apparatus by the user.

The flash memory 20 includes a control program storing domain 20a, a data table storing domain 20b, and a preset list storing domain 20c. The control program storing domain 20a stores a program for controlling the broadcast receiving apparatus. The data table storing domain 20b stores a data table of an established service list associated with the reception region. The preset list storing region 20c is capable of registering, as a preset list, a service list to be used at the time of the reception operation.

The following description refers to an operation for receiving one-segment broadcasting with the broadcast receiving apparatus as shown in FIG. 1.

First, when the operating part 19 accepts an instruction to start reception of a broadcast, the CPU 18 reads out service lists registered in the preset list storing domain 20c of the flash memory 20 and stores the same service lists in the RAM 21.

Next, the CPU 18 selects an arbitrary service in the service lists stored in the RAM 21 and sends a tuning instruction based on information of the service. Accepting the tuning instruction sent from the CPU 18, the tuner 11 selects a predetermined broadcast signal among broadcast signals sent from the antenna 10. The tuner 11 sends the thus selected broadcast signal to the demultiplexer 12. The demultiplexer 12 generates a video stream and an audio stream based on the broadcast signal. The demultiplexer 12 sends the video stream to the video decoder 13, and sends the audio stream to the audio decoder 14. The video decoder 13 transforms the video stream into a video signal and sends the video signal to the display device 16. The display device 16 displays a video on the basis of the video signal sent from the video decoder 13. The audio decoder 14 transforms the audio stream into an audio signal, and sends the audio signal to the amplifier 15. The amplifier 15 amplifies the audio signal sent from the audio decoder 14, and sends the audio signal to the speaker 17. The speaker 17 transforms the audio signal sent from the amplifier 15 into a sound/voice and emits the sound/voice.

When the operating part 19 accepts an instruction for switching the services, the CPU 18 designates a service following or preceding the currently-selected service in the service list stored in the RAM 21 (up-down tuning).

The switching of the services is not limited to the up-down tuning, but alternatively it can be performed as a selection from lists. First, the CPU 18 sends the service lists stored in the RAM 21 to the display device 16. The display device 16 displays the service lists sent from the CPU 18. Next, referring to the service lists displayed on the display device 16, the user operates the operating part 19 so as to select an arbitrary service. When the operating part 19 accepts an instruction to select a service, the CPU 18 sends a tuning instruction to the tuner 11, on the basis of the information of the selected service.

### 2. Method of Setting Reception Channel

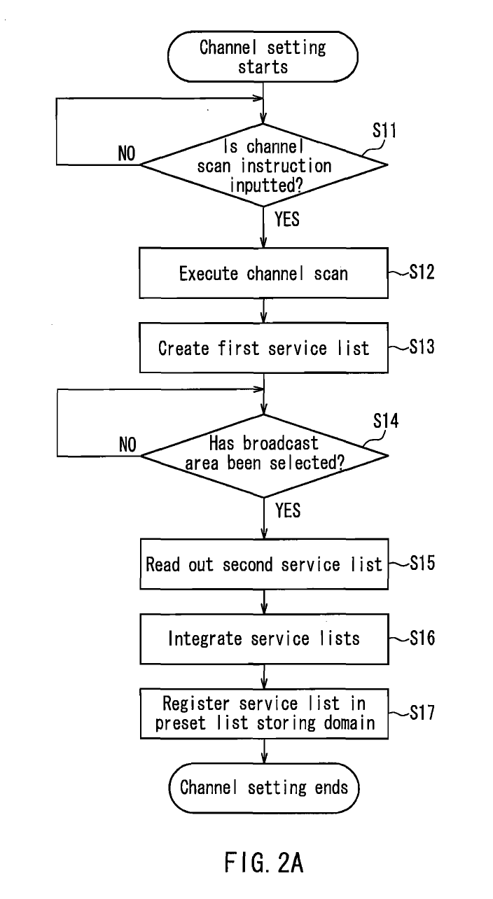

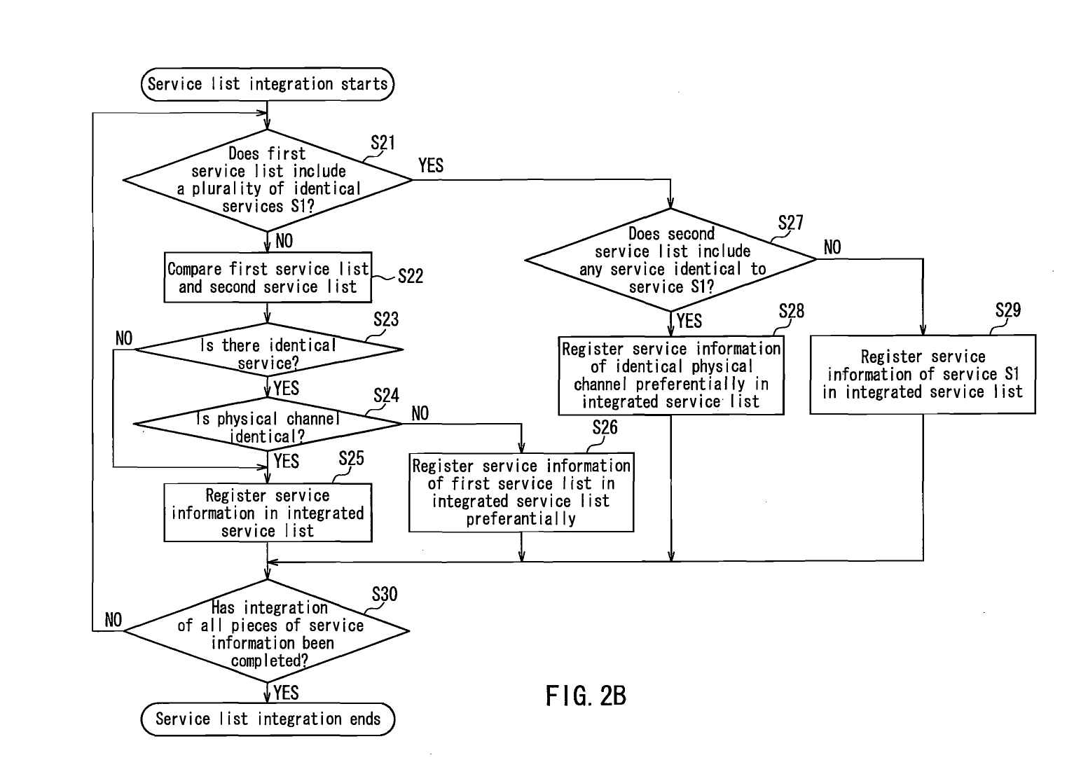

FIG. 2A is a flow chart showing an operation of setting a reception channel of a broadcast receiving apparatus. Hereinafter, the operation of setting the reception channel of the broadcast receiving apparatus will be described.

First, when the operating part 19 accepts an instruction to execute a channel scan (S11), the CPU 18 sends a channel scan instruction to the reception system 1. The reception system 1 executes the channel scan on the basis of the channel scan instruction (S12). Specifically, the reception system 1 operates the tuner 11 and tunes channels 13-62 sequentially, and sends information of receivable services to the CPU 18.

Next, the CPU 18 stores in the RAM 21 the service information sent from the reception system 1, and creates a first service list in the RAM 21. The first service list is a service list created by executing the channel scan (S13).

Next, when the operating part 19 accepts an instruction to select a broadcast area (S14), the CPU 18 reads out a second service list associated with the selected broadcast area, from the data table storing domain 20b of the flash memory 20. The CPU 18 stores the thus readout second service list in the RAM 21 (S15).

Next, the CPU 18 integrates the first service list and the second service list, both of which are stored in the RAM 21, and creates a new service list (integrated service list). The operation for integrating the first service list and the second service list will be described later (S16).

Next, the CPU 18 registers the integrated service list stored in the RAM 21, in the preset list storing domain 20c of the flash memory 20 (S17).

The procedure as shown in FIG. 2A includes a step of executing the channel scan (S12), which is followed by a selection of a broadcast area by a user (S14). In an alternative procedure, a user can select a broadcast area and then execute a channel scan.

### 3. Integration of Service Lists

FIG. 2B is a flow chart showing a procedure of service list integration. FIG. 2B shows specifically the step S16 in FIG. 2A.

In executing a step of service list integration, first, the CPU 18 checks whether a plurality of services S1 of an identical name have been registered or not in the first service list stored in the RAM 21 (S21). When deciding that a plurality of services S1 of an identical name have not been registered in the first service list, the CPU 18 goes onto a step S23; when deciding that a plurality of services S1 of an identical name have been registered in the first service list, the CPU 18 goes onto a step S27.

Next, the CPU 18 compares the first service list and the second service list (S22).

Next, the CPU 18 decides whether services of an identical name have been registered in the first service list and the second service list (S23).

Next, when deciding that services of an identical name have been registered in the first service list and the second service list, the CPU 18 compares the respective physical channels of the services having the same name (S24).

When deciding that the same services are registered in the first service list and the second service list and that the physical channels corresponding to the services coincide with each other (decision of YES in S24), the CPU 18 registers service information including the services in an integrated service list (S25).

When deciding that the identical services have been registered in the first service list and the second service list and that the physical channels corresponding to the services are different from each other (decision of NO in S24), the CPU 18 registers service information of the first service list in the integrated service list (S26).

When deciding that a plurality of services S1 of an identical name have been registered in the first service list (decision of YES in S21), the CPU 18 decides whether any service of the same name as the service S1 has been registered in the second service list (S27).

When deciding that a service S2 of the same name as the service S1 has been registered in the second service list (decision of YES in S27), the CPU 18 compares the physical channel corresponding to the service S1 and the physical channel corresponding to the service S2, and registers information of services having coincident physical channels, in the integrated service list (S28).

When deciding that a service of the same name as the service S1 has not been registered in the second service list (decision of NO in S27), the CPU 18 registers service information corresponding to the service S1, in the integrated service list (S29).

The CPU 18 executes the above-described integration with respect to all pieces of the service information in the first service list and the second service list (S30).

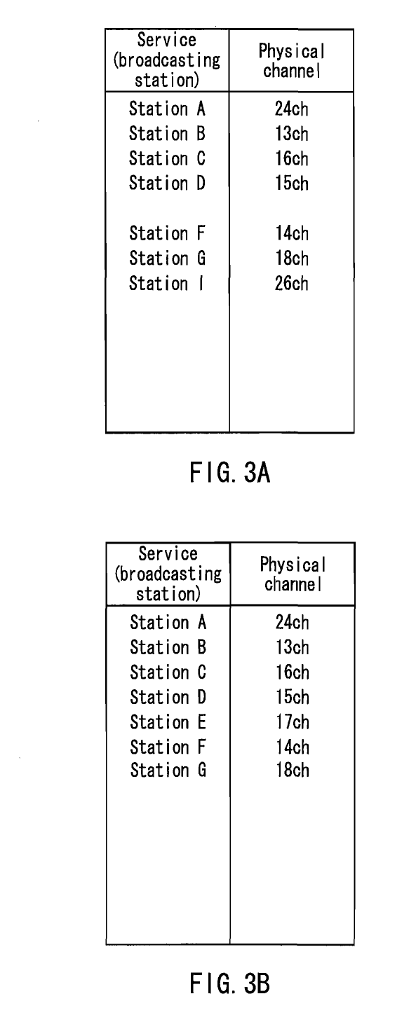

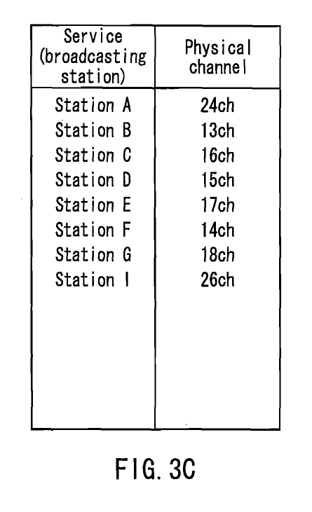

FIG. 3A shows a first service list obtained by locating a broadcast receiving apparatus at an arbitrary reception site in the broadcast area X and executing a channel scan. FIG. 3B shows a second service list associated with a reception region selected by the user. FIG. 3C shows an integrated service list obtained by integrating the first service list as shown in FIG. 3A and the second service list as shown in FIG. 3B. FIGS. 3A-3C refer to First Example.

Both the first service list (FIG. 3A) and the second service list (FIG. 3B) include service information of a station A, a station B, a station C, a station D, a station F, and a station G. The service information of a station I in the first service list is not registered in the second service list. The service information of a station E in the second service list is not registered in the first service list. Here, “service information” denotes information including a service (a broadcasting station name) and a physical channel.

In a case of integrating the first service list as shown in FIG. 3A and the second service list as shown in FIG. 3B with reference to the flow as shown in FIG. 2B, first, it should be noted that the station A, the station B, the station C, the station D, the station F and the station G as shown in FIG. 3A are the services respectively identical to the counterparts in FIG. 3B (broadcasting stations) and their physical channels also are identical to each other. In such a case where the services and the physical channels respectively in the first service list coincide with those in the second service list, the services and the physical channels are integrated into one piece of service information in the integrated service list as shown in FIG. 3C. This integration is a procedure based on the step S21 (decision of NO), the step S23 (decision of YES), the step D24 (decision of YES) and the step S25 in FIG. 2B.

The service information of the station I in the first service list as shown in FIG. 3A is not registered in the second service list as shown in FIG. 3B. Such service information registered only in the first service list is registered directly in the integrated service list as shown in FIG. 3C. This integration is a procedure based on the step S21 (decision of NO), the step S23 (decision of NO), and the step of S25 in FIG. 2B.

Furthermore, the service information of the station E in the second service list as shown in FIG. 3B is not registered in the first service list as shown in FIG. 3A. Such service information registered only in the second service list is registered directly in the integrated service list as shown in FIG. 3C. This integration is a procedure based on the step S21 (decision of NO), the step S23 (decision of NO), and the step of S25 in FIG. 2B.

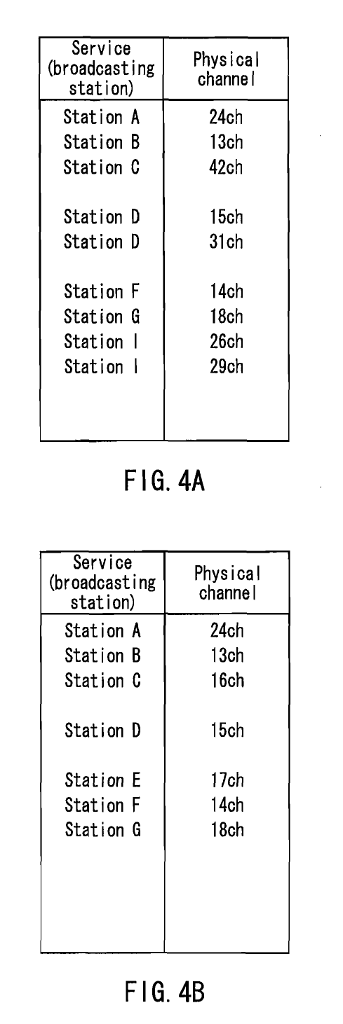

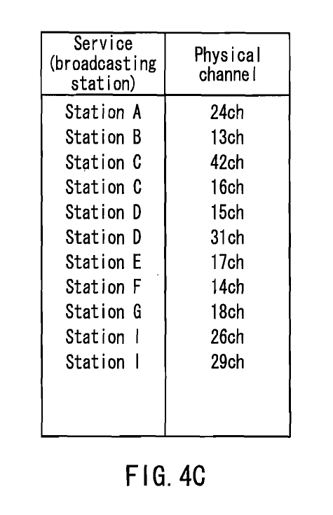

FIG. 4A shows a first service list obtained by setting a broadcast receiving apparatus at an arbitrary reception site in a broadcast area Y and executing a channel scan. FIG. 4B shows a second service list associated with a reception region selected by a user. FIG. 4C shows an integrated service list obtained by integrating the first service list as shown in FIG. 4A and the second service list as shown in FIG. 4B. FIGS. 4A-4C refer to Second Example.

Both the first service list (FIG. 4A) and the second service list (FIG. 4B) include service information of a station A, a station B, a station C, a station D, a station F, and a station G. The service information of a station I in the first service list has not been registered in the second service list. The service information of a station E in the second service list has not been registered in the first service list. In the first service list, respectively two pieces of service information have been registered for the station D and the station I. The service information of the station C has been registered in both the first service list and the second service list, but the physical channels are different from each other.

In a case of integrating the first service list as shown in FIG. 4A and the second service list as shown in FIG. 4B with reference to the flow as shown in FIG. 2B, it should be noted first that the service information of the station C has been registered in both the first service list and the second service list, but the physical channels are different from each other. This indicates that at the time of executing the channel scan, reception at the physical channel ‘16’ was not available, and reception at another physical channel ‘42’ was achieved. Just like this example, in a case where services identical to each other and having physical channels different from each other have been registered in both the first service list and the second service list, the physical channel of the first service list is registered preferentially in the integrated service list during the integration procedure. Specifically, as shown in FIG. 4C, the service information of the physical channel ‘42’ is placed in the higher order of the integrated service list, and the service information of the physical channel ‘16’ is placed in an order lower than the service information of the physical channel ‘42’. This is because the physical channel actually received through the channel scan may be more receivable even after setting the reception channel. As a result of integration in this manner, at the time of receiving a one-segment broadcasting with a broadcast receiving apparatus, it is possible to select preferentially a service corresponding to a receivable physical channel, and thus the convenience can be improved. This integration is a procedure based on the step S21 (decision of NO), the step S22, the step S23 (decision of YES), the step S24 (decision of NO) and the step S26 in FIG. 2B.

Concerning the service information of the station D, two pieces of information are registered in the first service list, and one piece is registered in the second service list. Among the pieces of service information of the station D registered in the first service list, one of the service information has a physical channel of ‘15’ and the other service information has a physical channel of ‘31’. The service information of the station D registered in the second service list has a physical channel of ‘15’. In a case where a plurality of identical services have been registered in the first service list and where the physical channel corresponding to one of the plural services and the physical channel corresponding to the service registered in the second service list coincide as in this example, the service information having the coincident physical channel is registered preferentially in the integrated service list. Specifically, as shown in FIG. 4C, the service information having the physical channel ‘15’ coincident between the first service list and the second service list is placed in a higher order in the integrated service list. The service information having a non-coincident physical channel ‘31’ is placed in an order lower than the service information having the physical channel of ‘15’ in the integrated service list. The reason is that the physical channel whose actual reception result coincides with the reception region selected by the user may be more receivable. This integration is a procedure based on the step S21 (decision of YES), the step S27 (decision of YES), and the step S28 in FIG. 2B.

The service information of the station I has been registered only in the first service list. Further, a plurality of pieces of the service information of the station I have been registered in the first service list, and their physical channels are different from each other. In such a case where a plurality of identical services have been registered only in the first service list, the service information of the smaller physical channel is registered preferentially in the integrated service list. Specifically, as shown in FIG. 4C, among the pieces of the service information of the two stations I, the service information of a physical channel ‘26’ is placed in the higher order in the integrated service list. The service information of the physical channel ‘29’, which is larger than the physical channel ‘26’, is placed in an order lower than the service information of the physical channel ‘26’ in the integrated service list. The reason is as follows. In comparison between a relay station used principally and a relay station used in a secondary manner, the relay station used in a secondary manner tends to be assigned with a larger physical channel, and taking this into consideration, the relay station used principally may have a higher reception possibility. This integration is a procedure based on the step S21 (decision of YES), the step S27 (decision of NO), and the step S29 in FIG. 2B.

Further, the service information of the station A, the station B, the station F and the station G has been registered in both the first service list and the second service list. The service information of the station A, the station B, the station F and the station G in the first service list coincides with the service informations of the station A, the station B, the station F and the station G in the second service list. Therefore, the service informations of the station A, the station B, the station F and the station G are registered directly in the integral service list. This integration is a procedure based on the step S21 (decision of NO), the step S22, the procedure S23 (decision of YES), the step S24 (decision of YES) and the step S25 in FIG. 2B.

Further, the service information of the station E has been registered only in the second service list. Therefore, the service information of the station E is registered directly in the integral service list. This integration is a procedure based on the step S21 (decision of NO), the step S22, the step S23 (decision of NO) and the step S25 in FIG. 2B.

### 4. Effect of Embodiment and the Like

According to the present embodiment, even when reception happens to fail due to a bad reception condition at the time of channel scan and registration is not performed, a reception from an established service list associated with the reception region is available. Further, even a service not included in the preset service list can be registered as one service list if the service list can be received at the reception site.

According to the present embodiment, the broadcast area can be selected from broadcast areas stored in the data table storing domain 20b of the flash memory 20. Thereby, a user can select any suitable service list from the established service lists associated with the broadcast area.

According to the present embodiment, since the integrated service list is stored as a preset list in the flash memory 20, a newly created service list can be held as a preset list, and thus there is no need of setting a service list in the next use.

According to the present embodiment, in a case where identical services have been detected in the first service list and the second service list on an identical physical channel, the services are integrated as one service information on the integrated service list. Thereby, identical service information can be registered in a service list without duplication, and thus a lean and simple service list can be created.

According to the present embodiment, in a case where a plurality of identical services of different physical channels have been registered in the first service list, the service information of the smaller physical channel value is registered preferentially. Thereby, when reception of identical services is achieved on different physical channels, the services are listed in accordance with an order of reception possibility, or the services are integrated to a physical channel having the higher reception possibility, and thus a simple and convenient service list can be created.

According to the present embodiment, in a case where information of identical services of different physical channels has been registered in the first service list and the second service list, if a service identical to a service in the second service list has been registered in the first service list on the same physical channel, the service is registered preferentially in the integrated service list. On the other hand, if a service identical to a service in the second service list has not been registered in the first service list on the same physical channel, the service information of the different physical channel in the first service is registered preferentially. Thereby, when reception of identical services is achieved on different physical channels, the services to be registered in the integrated service list are listed in accordance with an order of reception possibility, or the services are integrated to a physical channel having the higher reception possibility, and thus a simple and convenient service list can be created.

According to the present embodiment, the expression “registered preferentially” here indicates to be placed in a higher order in the integrated service list in comparison with unpreferential service information. In the present embodiment, unpreferential service information is placed in an order lower than the service information to be registered preferentially. Alternatively, the unpreferential service information can be prevented from being registered in the integrated service list.

In the present embodiment, the services are identified as shown in the steps S21, S23 and S27 in FIG. 2B. In a case of a one-segment broadcasting, it is possible to use a network ID contained in a broadcasting stream or a service ID, for the purpose of this identification.

The broadcast receiving apparatus of the present application is used particularly preferably in a portable broadcast receiving apparatus that receives a one-segment broadcasting, but the broadcast receiving apparatus also can be used for a portable broadcast receiving apparatus that receives not only a one-segment broadcasting but all kinds of terrestrial digital broadcasting. Further, the broadcast receiving apparatus can be used not only for the terrestrial digital broadcasting but analog television broadcasting and radio broadcasting.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A broadcast receiving apparatus that receives a broadcast wave and reproduces video, audio or data, the broadcast receiving apparatus comprising:
a channel scanner that detects presence or absence of receivable services for all channels within a reception bandwidth and creates a first service list of receivable services;
a service list storage that stores a broadcast area and at least one second service list associated with the broadcast area; and
a service list integrator that integrates the first service list and the second service list so as to create an integrated service list,
in a case where identical services have been registered on an identical physical channel in the first service list and the second service list, the service list integrator integrates the services into one piece of service information.

2. The broadcast receiving apparatus according to claim 1, wherein selection of the broadcast area from broadcast areas stored in the service list storage is allowed.

3. The broadcast receiving apparatus according to claim 1, further comprising a memory capable of storing the integrated service list as a preset list.

4. The broadcast receiving apparatus according to claim 1, wherein in a case where a plurality of identical services of different physical channels have been registered in the first service list, the service list integrator registers service information of the smaller physical channel value preferentially in the integrated service list.

5. The broadcast receiving apparatus according to claim 1, wherein in a case where service information of identical services of different physical channels has been registered in the first service list and the second service list,
if a service identical to a service in the second service list has been registered in the first service list on the same physical channel, the service list integrator registers the service information preferentially in the integrated service list, and
if a service identical to a service in the second service list has not been registered in the first service list on the same physical channel, the service list integrator registers the service information of the different physical channel in the first service list preferentially in the integrated service list.

6. A broadcast receiving method for receiving a broadcast wave and reproducing video, audio or data, comprising:
detecting presence or absence of receivable services for all channels in the reception bandwidth;
creating a first service list of receivable services;
reading out from a memory a second service list associated with the broadcast area, and
integrating the first service list and the second service list so as to create an integrated service list,
in creating the integrated service list, in a case where identical services have been registered on different physical channels in the first service list and the second service list, the services are integrated into one piece of service information.

7. The broadcast receiving method according to claim 6, wherein selection of the broadcast area from the broadcast areas stored in the service list storage is allowed.

8. The broadcast receiving method according to claim 6, further comprising a procedure of storing the integrated service list as a preset list.

9. The broadcast receiving method according to claim 6, wherein in creating the integrated service list, in a case where a plurality of identical services of different physical channels have been registered in the first service list, service information of the smaller physical channel value is registered preferentially in the integrated service list.

10. The broadcast receiving method according to claim 6, wherein in a case where service information of identical services of different physical channels has been registered in the first service list and the second service list,
if a service identical to a service in the second service list has been registered in the first service list on the same physical channel, the service information is registered preferentially in the integrated service list, and
if a service identical to a service in the second service list has not been registered in the first service list on the same physical channel, the service information of the different physical channel in the first service list is registered preferentially in the integrated service list.
